(19) United States
(12) Patent Application Publication
(10) Pub. No.: US 2026/0062539 A1
(43) Pub. Date: Mar. 5, 2026

(54) Asphalt Modifier

(71) Applicant: Innophos, Inc., Cranbury, NJ (US)

(72) Inventor: Juan Lopez, III, Providence, RI (US)

(73) Assignee: Innophos, Inc., Cranbury, NJ (US)

(21) Appl. No.: 19/311,666

(22) Filed: Aug. 27, 2025

Related U.S. Application Data
(60) Provisional application No. 63/689,980, filed on Sep. 3, 2024.

(51) Int. Cl. C08K 9/10; C08K 3/32; C08L 95/00

(52) U.S. Cl. CPC C08K 9/10; C08L 95/00; C08K 2003/329; C08L 2207/20; C08L 2310/00; C08L 2555/50; C08L 2555/86

(57) ABSTRACT

Disclosed herein is an asphalt modifier comprising at least two modifiers, wherein one of the asphalt modifiers is at least a plastic modifier used to encapsulate the other modifier. The other asphalt modifier is preferably polyphosphoric acid or solid phosphoric acid. The plastic modifier can be recycled plastic.

### BACKGROUND OF THE INVENTION

Field of the Invention The present invention generally relates to modifiers for use in modifying the properties of asphalt. More particularly, the present invention is directed towards an asphalt modifier comprising polyphosphoric acid and plastic for modifying the performance grade of asphalt.

According to the American Society of Testing Material (‘ATSM’), asphalt is defined as “a dark brown to black cementitious material in which the predominant constituents are bitumens which occur in nature or are obtained in the petroleum processing” (i.e., obtained by fractional distillation of petroleum). In industry, the terms asphalt and bitumen are used interchangeably, with asphalt more commonly used in the United States, and bitumen more commonly used outside the United States. For the present application, as well as for clarity, the term bitumen is used to refer to the ‘dark brown to black cementitious material’, or binder, while asphalt is used to refer to asphalt concrete or asphalt cement; that is, the combination of at least bitumen and aggregates. Further, modified asphalt would accordingly refer to asphalt that has been modified by the addition of one or more additives added to affect performance characteristics.

Bitumen used in forming asphalt is available in different grades, depending upon the source of the crude oil from which the bitumen is derived. There are various ways to grade bitumen, such as penetration grading, viscosity grading, and performance grading. For penetration grading, bitumen is classified by the depth to which a standard needle penetrates the bitumen under specified test conditions. This needle test characterization indicates the hardness of bitumen, with a lower penetration indicating a harder bitumen. Specifications for penetration graded bitumen normally state the penetration range for a grade (e.g., 50/70). Viscosity graded bitumen are graded and specified by their viscosity at a standard temperature (typically 135° C.). Specifications for viscosity graded bitumen normally give the nominal viscosity preceded by a V (e.g., V1500). Unfortunately, penetration and viscosity grading are somewhat limited in their ability to fully characterize bitumen for use in hot mixture asphalt (‘HMA’) pavement.

Performance grading (‘PG’) incorporates tests and specifications that more accurately and fully characterize bitumen for use in HMA pavements. For bitumen, this involves expected climatic conditions as well as aging considerations. Like the penetration and viscosity grading systems, performance grading uses a common battery of tests yet also specifies that a particular bitumen must pass these tests at specific temperatures that are dependent upon specific climatic conditions where used. Performance grading is reported using two numbers—the first being the average seven-day maximum pavement temperature (° C.) and the second being the minimum pavement design temperature likely to be experienced (° C.). For example, a performance grade (‘PG’) 58-28 bitumen is intended for use where the average seven-day maximum pavement temperature is 58° C. (136° F.) and the expected minimum pavement temperature is −28° C. (−18.4° F.). Generally, performance grade bitumen that differs in the high and low temperature specification by 90° C. (194° F.) or more typically require some sort of modification.

The PG system described above was primarily developed around unmodified asphalts, with G*/sin 8 being the high temperature specification parameter and rutting performance indicator. G*/sin 8 is determined by a dynamic shear rheometer (‘DSR’), an instrument used to characterize the viscous and elastic behavior of materials, particularly asphalt binders. The specifications for performance-graded asphalt binder were adopted as AASHTO M 320-21 (“Standard Specification for Performance-Graded Asphalt Binder”).

In an attempt to improve the durability and reliability of asphalt pavements in meeting climate, traffic, and other requirements, the use of modified asphalt instead of raw or unmodified asphalt has long been recommended as an effective approach. Modified bitumen refers to bituminous binders whose performance properties (e.g., elasticity, adhesive, or cohesive strength) have been modified by the addition of one or more additives. These modifying additives or modifiers include fillers, extenders, polymers, oxidants, rejuvenators, antioxidants, antistripping agents, waste materials (e.g., crumb rubber and/or recycled plastic), and polyphosphoric acid, among others.

Asphalt modifiers can further include various types of polymers that can be added to the bitumen to increase HMA stiffness at high service temperatures, increase HMA elasticity at medium service temperatures to resist fatigue cracking, or decrease HMA stiffness at low temperatures to resist thermal cracking. Antistripping agents can be added to bitumen or asphalt to minimize the stripping of bitumen from aggregates. Extenders can be added as a substitute for a portion of the bitumen to decrease part of the bitumen required, for example, when recycling asphalt.

The wet and dry processes are the main methods for incorporating modifiers into asphalt mixtures. In the wet process, modifiers are mixed with the bitumen binder at high temperatures prior to mixing with aggregates. Examples of modifiers that can be used in the wet process include plastics such as linear low-density polyethylene (‘LLDPE’), low-density polyethylene (‘LDPE’), high-density polyethylene (‘HDPE’), and polypropylene (‘PP’), as well as Paraffin and Fisher-Tropsch wax, polystyrene, polyurethane, plasticizers such as reactive elastomeric terpolymers (‘RET’), SBS, SBR, fibers, rubber, and ground tire rubber. In the dry process, modifiers are first mixed with hot aggregates, and then the bitumen binder to produce the asphalt mix. Modifiers for the dry process include those mentioned for the wet process, as well as PET, polycarbonate, nylon, polyamide, polyester, PTFE, and multilayer film.

Often the bitumen that an asphalt producer receives does not meet the performance grade required for the location in which the asphalt is to be laid. For example, the bitumen available to the producer may be PG 64-22 but regulations or geography may require PG 70-22 or even PG 76-22. To meet the required grade, the bitumen can be chemically modified by adding an appropriate amount of polyphosphoric acid (‘PPA’). This PPA modification improves the high temperature rheological properties of the bitumen without affecting its low temperature rheological properties (i.e., the PPA addition increases the average 7-day maximum pavement temperature from 64° C. to 70° C. or higher, depending on the amount of PPA added, while the minimum temperature remains the same). Addition of PPA can also increase the stiffness of the bitumen, depending on the source of the bitumen.

Recycled waste products have been used in the asphalt industry for decades with varying levels of success. Asphalt itself is one of the most recycled materials in the United States, with millions of tons of asphalt mixtures recycled back into new asphalt mixtures in recent years. In addition to using reclaimed asphalt pavement (‘RAP’), asphalt mixtures can also contain recycled tire rubber or crumb rubber, steel slag, recycled asphalt shingles, recycled glass, and more.

Plastic is one type of material that can be recycled into asphalt. It is estimated that only about 9% of the world's plastic is recycled annually, with over 80% ending up in landfills or in the natural environment. According to the Environmental Protection Agency, plastics account for over 35 million tons of waste in the United States, or approximately 13% of the total waste generated in the United States. Only about 8.7% of this plastic waste is recycled, and of the remaining waste, approximately 15.7% is combusted and 75.6% sent to landfill. Nearly 20% of all landfill waste in the United States is plastic.

Still, recycling plastic is quite complicated. Currently, there are at least seven types of waste plastic found in municipal solid waste, each having different chemical compositions and physical properties. These include high-density polyethylene (‘HDPE’), low-density polyethylene (‘LDPE’), polypropylene (‘PP’), polystyrene (‘PS’), polyethylene terephthalate (‘PET’), ethyl vinyl acetate (‘EVA’), and polyvinyl chloride (‘PVC’). Each type of plastic can differ in melting point. When used in asphalt, the melting point is important because, if recycled plastics are to modify the asphalt binder, they need to melt and become part of the binder. Most asphalt mixtures are produced at temperatures under 350° F. (177° C.; typically about 330-350° F., or 163-177° C.). Some plastics have a higher melting point than the asphalt mixture production temperature (e.g., polyethylene terephthalate, or ‘PET’, having a melting point greater than 482° F. (250° C.)) and therefore may not melt to blend with the binder or coat the aggregate. (Pellets of PET could possibly be utilized as a type of aggregate in the asphalt.)

Other plastics may not be used in asphalt due to health risks. For example, when polyvinyl chloride (‘PVC’) is heated, it can generate polychlorinated dibenzo-p-dioxins and dibenzofurans in the exhaust gases, which are harmful to human health and should be avoided.

Recycled plastics studied in recent years for use in asphalt include polyethylene (‘PE’), including linear low-density polyethylene (‘LLDPE’), low-density polyethylene (‘LDPE’), and high-density polyethylene (‘HDPE’), as well as polyethylene terephthalate (‘PET’) and polypropylene (‘PP’). These recycled plastics have been added into the asphalt binder by both the wet process and the dry process.

In the wet process, recycled plastics are added into the asphalt binder as polymer modifiers or bitumen replacement, with mechanical mixing required to achieve a homogenous modified binder blend. Recycled plastics with a low melting point (e.g., LLDPE, LDPE, and HDPE; that is, a melting point of about 105° C. to about 135° C.) are suitable for this process. Depending upon the process utilized (dry or wet), type of asphalt (hot or warm mix) and type of plastic, dosage of recycled plastics can vary from about 2 to about 8 percent by weight (wt %′) of asphalt binder.

In the dry process, recycled plastics are added directly into the mixture as either aggregate replacement, mixture modifiers, binder modifiers, or combinations thereof. For aggregate replacement, recycled plastics with a high melting point (i.e., above the typical production temperature of asphalt mixtures) are used, such as PET, PS, and polycarbonate (PC′). The dosage of recycled plastic as aggregate replacement in the dry process can vary from about 0.2 to about 1.0 wt % of total aggregate. When used as a mixture modifier, virtually all types of recycled plastics can be used.

Recycled plastics for asphalt modification have been shown to reduce the penetration and ductility and increase the softening point, viscosity, and high-temperature performance grade of asphalt binder. Still, use of recycled or waste plastic to modify asphalt presents various challenges, including stability, low-temperature performance, the modification mechanism, and laboratory problems of the asphalt blend. Further, recycled plastics and asphalt binder are susceptible to phase separation due to their differences in solubility parameter and thermodynamics. Accordingly, producing a homogenous and storage-stable binder is difficult due to this phase separation and may require the incorporation of a stabilizing agent such ethylene-vinyl acetate (‘EVA’), maleic anhydride (‘MA’), grafted LLDPE, nanosilica, organic montmorillonite, polyphosphoric acid (‘PPA’), solid phosphoric acid (‘SPA’), reactive elastomeric terpolymer (‘RET’), and styrene-butadiene-styrene (‘SBS’). Even with the stabilizer or compatibilizer, the resultant recycled plastic material binder can still be susceptible to phase separation after long term storage and thus have a limited shelf life.

Asphalt modification with plastic, particularly PE, has been known in the industry since at least the 1980's. PE modification has received less attention in recent years compared to other polymer modifications because the non-polar and non-aromatic nature of PE limits its ability to blend with asphalt binders. However, with the increasing emphasis on sustainability and environmental impact, use of plastics, particularly PE and especially from recycled sources, is gaining more attention. In general, the incorporation of waste plastics into asphalt mixtures can provide improvements in rutting resistance, fatigue resistance, and moisture resistance. However, issues with compatibility and low-temperature performance remain during the application of plastic modified asphalt.

As noted above, there is a need to mitigate the phase separation of recycled plastic material and asphalt binders. There is also a need to assess the compatibility between recycled plastics and other additives used in asphalt binders, particularly polyphosphoric acid.

### BRIEF SUMMARY OF THE INVENTION

Disclosed herein is a composition comprising polyphosphoric acid (‘PPA’) encapsulated in a plastic shell or blended with a plastic for modifying the properties of asphalt. This encapsulated PPA can exist in several forms, all of which involve a PPA core enclosed within a polymer shell or blended with the polymer shell. In one embodiment, the PPA is solid phosphoric acid (‘SPA’). The polymer shell can be formed from available plastics and/or rubbers including, but not limited to, polyethylene (HDPE, LDPE LLDPE, etc. as mentioned above), polypropylene, polystyrene, styrene-butadiene-styrene (‘SBS’), styrene-butadiene-rubber, multi-layer films, and other polymers. In one embodiment, the polymer utilized is recycled plastic. In one embodiment, the recycled plastic is polyethylene (‘PE’).

In one simple form, the composition can be made through the vertical fill of a plastic pouch, for example, a polyethylene pouch, with PPA and then heat-sealed closed. Other non-limiting embodiments include packets, capsules, beads, thermoformed containers, and so forth. If the melt temperature of the plastic is below about 160-165° C., or below 160-165° C. (typical asphalt storage temperature), then the encapsulated material can be added directly to the heated asphalt.

In addition to or instead of PPA, the plastic pouch can further be filled with other compounds compatible with the plastic and/or PPA. Other compatible additives include high temperature performance modifiers (plastomers, elastomers, waxes, crumb rubber, isocyanate etc.), crosslinkers, scavengers, fibers, odor reducers, etc. Materials that are not compatible will include products that weaken or lessen the structural integrity of plastic. Incompatible materials may be certain low temperature performance modifiers, antistripping agents, extender oils, rejuvenators, etc. Products compatible with plastic but incompatible with PPA should be stored in a different plastic compartment or encapsulation separately.

Accordingly, in one embodiment, the present invention provides a composition comprising a first asphalt modifier, wherein the first asphalt modifier comprises at least polyphosphoric acid, and a second asphalt modifier, wherein the second asphalt modifier comprises a plastic modifier, wherein the second asphalt modifier encapsulates the first asphalt modifier, and wherein the first asphalt modifier and second asphalt modifier are present in the composition in a ratio of about 1:1 to about 1:6, preferably 1:1 to 1:6.

In a further embodiment, the plastic modifier in the second modifier comprises recycled plastic.

Preferably, the plastic modifier is chosen from linear low-density polyethylene, low-density polyethylene, high-density polyethylene, polypropylene, and combinations thereof.

In a further embodiment the composition further comprises at least one additional asphalt modifier, wherein the second asphalt modifier encapsulates the at least one additional asphalt modifier.

The present invention also provides asphalt comprising the composition comprising the first and second asphalt modifiers and, optionally, at least one additional asphalt modifier.

In another embodiment, the present invention provides a first asphalt modifier, wherein the first asphalt modifier comprises solid phosphoric acid, and a second asphalt modifier, wherein the second asphalt modifier comprises a plastic modifier, wherein the first asphalt modifier and second asphalt modifier are blended together to form encapsulated solid phosphoric acid, wherein the first asphalt modifier and second asphalt modifier are present in the composition in a ratio of about 1:1 to about 1:6, preferably 1:1 to 1:6. Preferably, the plastic modifier is chosen from linear low-density polyethylene, low-density polyethylene, high-density polyethylene, polypropylene, and combinations thereof. In a further embodiment, the plastic modifier in the second modifier comprises recycled plastic. The present invention further provides for asphalt comprising the encapsulated solid phosphoric acid.

The incorporation of the encapsulated material into bitumen will, in most cases, require low heat (e.g., about 163° C. or lower, or 163° C. or lower) and low shear (e.g., about 200 to 500 rpm, or 200 to 500 rpm). This is in comparison to SBS-modified asphalt, requiring temperatures of 170-190° C. and high shear of about 2000 rpm, or 2000 rpm.

### BRIEF DESCRIPTION OF THE SEVERAL VIEWS OF THE DRAWINGS

All Figures presented herein are illustrative and not intended to limit the full scope of the claims.

FIG. 1 is a graph illustrating the separation differences between top and bottom PG from Example 3 below.

### DETAILED DESCRIPTION OF THE INVENTION

In describing the preferred embodiment, certain terminology will be utilized for the sake of clarity. Such terminology is intended to encompass the recited embodiment, as well as all technical equivalents which operate in a similar manner for a similar purpose to achieve a similar result.

For the present application, the term “composition” refers to the combination of PPA with a plastic, wherein the PPA is encapsulated in a plastic shell or blended with a plastic. Other additives may optionally be included in the composition, but the composition comprises at least the PPA and the plastic. These other additives can be, when the PPA is encapsulated in the plastic shell, encapsulated together in the shell or optionally encapsulated separately in a plastic shell. When the PPA is blended with the plastic, the other additive(s) can be blended with the PPA and plastic or blended separately with the plastic.

As used herein, the term “effective amount” of a composition refers to an amount effective at dosages and for periods of time sufficient to achieve a desired result. For example, the “effective amount” can refer to that amount of encapsulated PPA sufficient to effect a change in the high temperature performance grade of bitumen modified with the composition. The amount of composition required according to this disclosure that constitutes an effective amount” will vary depending on the plastic utilized and its compatibility with PPA, as well as any further additives that may be included in the composition.

“Modified binder” refers to bitumen whose performance properties (e.g., elasticity, adhesive or cohesive strength) has been modified by the addition one or more additives. Additives include those noted above, particularly at least one or more types of plastic and/or PPA.

“Encapsulated” refers to the act of enclosing one material in another. The encapsulating material can have different properties than the material that is encapsulated, allowing for surface properties different from what the encapsulated material would have on its own (e.g., corrosion).

Unless indicated otherwise, all proportions and percentages recited throughout this disclosure are by weight.

In a broad sense, the present invention provides a composition for modifying asphalt comprising PPA in an encapsulated form. Liquid PPA is a highly corrosive, viscous liquid that can freeze at room temperature, necessitating special storage requirements, including heating the PPA when dosing into asphalt. By encapsulating the PPA, corrosivity of the acid is greatly reduced as well as volatility, improving the dosing of the acid into the asphalt.

Various embodiments of the present composition are envisioned. As previously mentioned, and illustrated in the Examples below, one embodiment is a plastic bag with at least PPA contained therein. In one embodiment, the plastic is in the form of a plastic packet, such as a detergent pod wherein the composition contained in the pod is at least PPA. The smaller the size of the pod the better for dosing. For example, a pod that is about half the size of current commercially available detergent pods would be preferred. In another embodiment, the plastic is in the form of a bottle or tube with at least PPA contained therein. Again, the smaller the size of the bottle or tube the better for use. A third embodiment is a plastic cube or pod, for example, a 2″×2″ cube filled with PPA and unprocessed resin. Another embodiment is in the form of small beads with PPA encapsulated therein. Each of these embodiments have their challenges for commercialization, including cost to produce and size of product.

In another embodiment, solid phosphoric acid (‘SPA’) is used. Such SPA is well known in the art for use as a catalyst (see, e.g., U.S. Pat. Nos. 2,713,560, 3,044,964, 3,050,472, 3,050,473, 3,170,885, 3,673,111 and 5,081,086, as well as the article by Coetzee et al. entitled “An improved solid phosphoric acid catalyst for alkene oligomerization in a Fischer-Tropsch refinery” (Applied Catalysis A: General, vol. 308 (2006), pp. 204-209)). The SPA catalyst is traditionally produced by mixing phosphoric acid with diatomaceous earth, followed by extrusion and calcination at high temperatures.

SPA for the present invention is prepared in a similar fashion to that generally described above for the catalyst. Production results in SPA of varying size.

Various plastic polymers suitable for encapsulating the PPA are noted above. For sustainability concerns, in one embodiment the plastic is recycled plastic material. In one embodiment, the plastic is polyethylene. In a further embodiment, the plastic is low density polyethylene. When blending the plastic with the SPA, the plastic can be in the form of plastic pellets having a size of about 1.0 mm to about 10.0 mm (about 0.04 in to about 0.40 in).

In one embodiment, the weight (in particular, the weight %) ratio of PPA to plastic is from about 1.0 to 1.0 to about 1.0 to 6.0 weight %. For encapsulated PPA or SPA blended with plastic, the PPA is present in an amount of about 33.0% by weight of the encapsulated composition or product. When added to asphalt, it is preferred that the plastic is added in an amount of about 2.0 to about 2.5% by weight of the modified bitumen, and the PPA or SPA is added in an amount of about 0.5 to about 1.5% by weight of the modified bitumen. Preferably, the encapsulated SPA is in the form of pellets having a diameter of about 1.0 mm to about 25.0 mm (about 0.04 in to about 1.00 in) for addition to the bitumen binder, preferably about 1.0 mm to about 10.0 mm (about 0.04 in to about 0.40 in).

In another embodiment, the weight (in particular, the weight %) ratio of PPA to plastic is from 1.0 to 1.0 to 1.0 to 6.0 weight %. For encapsulated PPA or SPA blended with plastic, the PPA is present in an amount of 33.0% by weight of the encapsulated composition or product. When added to asphalt, it is preferred that the plastic is added in an amount of 2.0 to 2.5% by weight of the modified bitumen, and the PPA or SPA is added in an amount of 0.5 to 1.5% by weight of the modified bitumen. Preferably, the encapsulated SPA is in the form of pellets having a diameter of 1.0 mm to 25.0 mm (0.04 in to 1.00 in) for addition to the bitumen binder, preferably 1.0 mm to 10.0 mm (0.04 in to 0.40 in).

The invention is further illustrated by reference to the following examples.

### EXAMPLES

### Example 1—Proof of Concept

Three (3) samples were prepared by filling two (2) LDPE bags (purchased online from the Hudson Exchange, MOC1068067 LDPE Poly Tubing, Mini Roll, 2″ W×1000′ L, 2 Mil)—one bag inside the other with each double-bag weighing 2.65 g—with 2.65 g of polyphosphoric acid (‘PPA’) (i.e., a 1:1 ratio of plastic to PPA). The concentration of PPA utilized was 105% H₃PO₄ (76% P₂O₅). Each sample was then added to its own pint (265 g) container containing hot bitumen (PG 58-28, 163° C.) under low shear mixing (200 RPM) resulting in an overall concentration of 1.0% by weight polyethylene and 1.0% by weight PPA per total weight of modified bitumen. The samples were blended with the bitumen in the three containers and then stored at 163° C. together with a control container containing just bitumen (‘neat’) for one hour. After the one-hour storage, the samples showed uniform blending on the top and bottom of the container. Further, the PG grade increased from 62.0 (Control) to 70.0 (i.e., all three samples modified with LDPE and PPA). This illustrates that PPA can be encapsulated in plastic and then used to modify the performance grade of bitumen.

### Example 2—Plastic and Encapsulated PPA Storage Stability

Four (4) bitumen (PG 58-28) samples were subjected to a 48-hour storage stability test to test their separation according to ASTM Method D7173-20 (“Standard Practice for Determining the Separation Tendency of Polymer from Polymer-Modified Asphalt”). The samples were (1) neat bitumen (Control), (2) bitumen modified with 3.0% by weight LDPE (Additive 1), (3) bitumen modified with 2.0% by weight LDPE and 2.0% by weight PPA (liquid acid), wherein the PPA was encapsulated in the LDPE per Example 1 above (Additive 2), and (4) bitumen modified with 2.0% by weight LDPE and 2.0% by weight SPA (solid acid), wherein the SPA was encapsulated with the LDPE (Additive 3). (LDPE was purchased online from Elkay Plastics, FP20202 LD Seal Top Bags, 2 in.×2 in., 2 mil.) The concentration of PPA utilized in Additive 2 was 105% H₃PO₄ (76% P₂O₅). The SPA utilized in Additive 3 comprised 76% to 81% by weight PPA (about 85% to about 92% H₃PO₄, or about 62% to about 66% P₂O₅), with the balance diatomaceous earth.

Additives 1, 2, 3 and 4 were each thoroughly blended into separate quart (500 g) containers at 163° C. under low shear mixing (200 RPM) and then stored at 163° C. for 48 hours. At the end of this storage period, the top and bottom of each sample was tested according to AASHTO T 315 (“Standard Method of Test for Determining the Rheological Properties of Asphalt Binder Using a Dynamic Shear Rheometer (DSR)”). Following 48-hour storage, the neat bitumen (Control) had the same PG (PG 61° C.) for the top and bottom of the sample indicating no separation. The bitumen modified with 3.0% by weight LDPE (Additive 1) had significantly different PG's for the top (PG 100° C.) and bottom (PG 68.5° C.), indicating separation of the polymer (LDPE) and binder (bitumen). The bitumen modified with 2.0% by weight LDPE and 2.0% by weight PPA (Additive 2 according to the invention) had an increase in PG to about an average PG 83.4° C. compared to Sample 1, with the top PG about 85.4° C. and bottom PG about 81.4° C., indicating little to no separation between the binder and additives while providing an improvement in high temperature stiffness as indicated by the increase in PG. The bitumen modified with 2.0% by weight LDPE and 2.0% by weight SPA (Additive 3 according to the invention) had a significant increase in PG to about an average PG 71.9° C. compared to Sample 1, with the top PG about 73.9° C. and bottom PG about 69.9° C., indicating little to no separation between the binder and additives while providing an improvement in high temperature stiffness and prevention of rutting.

### Example 3—Plastic Separation Comparative with Other Plastics and Varying Wall Thickness

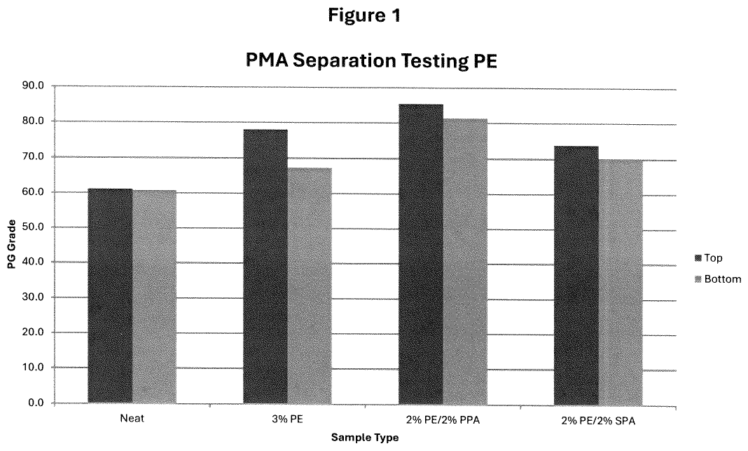

PPA, SPA, and various plastic additives with or without PPA or SPA were added to bitumen binder (PG 58-28) in pint size (250 g) steel paint containers under low shear mixing (200 rpm except as noted below for HDPE) for 2 hours at 160° C. (320° F.) to determine their effect on performance grade and storage stability (same ASTM method as in Example 2). The concentration of PPA utilized was 105% H₃PO₄ (76% P₂O₅). When encapsulated (PPA in plastic as illustrated in Example 1 above), the additives weighed from about 2.0 g to about 2.5 g. Each encapsulated additive was about 33.3% PPA by weight of the additive, with the remainder plastic (i.e., a 2:1 ratio of plastic to PPA). The plastic portion of the additive accounted for 2.0% by weight of the modified binder, and the PPA accounted for 1.0% by weight of the modified binder. Polypropylene (‘PP’) and High-Density Polyethylene (‘HDPE’) are more difficult to incorporate into asphalt. Therefore, to ensure incorporation into the binder, both the HDPE and PP additives were blended into the binder at about 180-185° C. (356-365° F.). Further, PPA encapsulated in PP was mixed at 345 rpm (low shear). For the HDPE additive, high shear (3200 rpm) was used for 2 hours followed by low shear (500 rpm) for 2 hours, and the sample size was increased from approximately 220 g to 1577.32 g to allow for use of the high shear mixer. Asphalt binder samples were tested according to AASHTO T 315. The additives and results are provided in the following Table 2 (see also, FIG. 1)—

TABLE 2

| | | | | | | Separation |
|---|---|---|---|---|---|---|
| | | Wall | PG Grade | PG Grade | Average | Top & |
| | Modification | Thickness | Top | Bottom | PG | Bottom |
| Additive | (% by weight) | (mil) | (° C.) | (° C.) | (° C.) | (° C.) |
| | Neat (Control) | N/A | 61.0 | 61.3 | 61.1 | 0.3 |
| A | 1.0% PPA | N/A | 67.1 | 67.3 | 67.2 | 0.3 |
| B | 2.0% LDPE ¹ | N/A | 65.8 | 65.6 | 65.7 | 0.2 |
| C | 3.0% LDPE ¹ | N/A | 100.0 | 68.5 | 84.2 | 31.6 |
| D | 1.0% PPA | 4.0 | 72.8 | 73.4 | 73.1 | 0.6 |
| | encapsulated in | | | | | |
| | 2.0% LDPE | | | | | |
| E | 1.0% PPA | 10.0 | 80.0 | 74.4 | 77.2 | 5.6 |
| | encapsulated in | | | | | |
| | 2.0% LDPE | | | | | |
| F | 1.0% PPA | 20.0 | 81.0 | 72.9 | 76.9 | 8.0 |
| | encapsulated in | | | | | |
| | 2.0% LDPE | | | | | |
| G | 1.0% PPA | 0.8 | 72.7 | 72.3 | 72.5 | 0.4 |
| | encapsulated in | | | | | |
| | 2.0% HDPE ² | | | | | |
| H | 1.0% PPA | 4.0 | 71.0 | 70.9 | 71.0 | 0.1 |
| | encapsulated in | | | | | |
| | 2.0% PP ³ | | | | | |
| I | 1.0% PPA | N/A | 65.4 | 73.0 | 69.2 | 7.6 |
| | encapsulated in | | | | | |
| | 2.0% PS ⁴ | | | | | |
| J | 1.0% PPA | N/A | 65.6 | 65.6 | 65.6 | 0.0 |
| | encapsulated in | | | | | |
| | 2.0% PET ⁴ | | | | | |
| K | 1.0% SPA | 4.00 | 69.3 | 67.8 | 68.6 | 1.50 |
| | encapsulated in | | | | | |
| | 2.0% LDPE | | | | | |

¹ Purchased online from the Hudson Exchange, MOC1068067 LDPE Poly Tubing, Mini Roll, 2″ W × 1000′ L, 2 mil.
² Purchased online from Cleanwrap Korea, Cleanwrap Cleanbag HDPE food storage roll bags, 30 cm × 40 cm.
³ Elkay Plastics FP20305 PP Seal Top Bags, 3 in. × 5 in., 2 mil.
⁴ Blend into binder failed due to high melting point of plastic (unmelted / unincorporated plastic material found in mix).

From the above results it is seen that the combination of PPA and plastic (Additives D-K) provided a greater PG grade increase (12.0° C. for Additive D—see Table 2) than PPA alone (Additive A—5.9° C.) or plastic alone (Additive B—4.6° C.). Further, as noted in Example 2 above, increasing the amount of plastic above a certain limit resulted in separation of the plastic from the binder (here, Additive C using LDPE at 3.0% by weight of the binder). Therefore, the amount of plastic added to the binder should preferably be about 0.5% to about 3.0% by weight. In another embodiment, the amount of plastic added to the binder is in an amount of about 0.5% to about 2.0% by weight of the modified binder. Likewise, the amount of plastic added to the binder should be 0.5% to 3.0% by weight, preferably 0.5% to 2.0% by weight of the modified binder.

### Example 4—Effect of SPA Size on Performance Grade (‘PG’)

Samples of various sizes of SPA were tested for performance in asphalt by dosing 1.0 wt % SPA into pint sized steel cans (250 g) of PG 58-28 asphalt binder at 163° C. with low shear mixing (200 RPM) for 1-, 2—, or 4-hour mix times. Neat (unmodified asphalt) was tested as received. SPA-1 was a powder form of SPA in which 80% passed through 14 Mesh (i.e., had a particle size of 1410 microns or smaller), 54% passed through 40 Mesh (i.e., had a particle size of 400 microns or smaller), and 30% passed through 100 Mesh (i.e., had a particle size of 150 microns or smaller). SPA-2 was a larger granular form of SPA in which 100% passed through 1 Mesh (i.e., had a particle size of 25400 microns or smaller), and 97% passed through 4 Mesh (i.e., had a particle size of 4750 microns or smaller). Asphalt binder samples were tested according to AASHTO T 315. The performance grade for SPA-1 and SPA-2 are presented in the following Table 3—

TABLE 3
Low Shear Mixing at 200 RPM (163° C.)

| Sample Type | Mix Time (hours) | Performance Grade |
|---|---|---|
| Neat | N/A | 60.8 |
| SPA-1 | 1 | 62.0 |
| SPA-1 | 2 | 62.4 |
| SPA-1 | 4 | 62.8 |
| SPA-2 | 1 | 60.7 |
| SPA-2 | 2 | 62.6 |
| SPA-2 | 4 | 62.5 |

While both SPA-1 and SPA-2 showed similar performance in asphalt (i.e., they all resulted in a similar performance grade enhancement of the asphalt), the smaller sized SPA-1 (e.g., powder size) incorporates better into asphalt, avoiding large chunks of insoluble diatomaceous earth, and is therefore preferred.

### Example 5—Manufacture of Encapsulated SPA

Solid phosphoric acid (‘SPA’) in an amount of 250 g or 300 g (two separate extrusions) was used as the P₂O₅ source. Encapsulation of the SPA in plastic was performed on a Thermo Fisher Scientific Process 11 Parallel Twin-Screw Extruder utilizing a 3.5 mm die. The extruder contained eight (8) heating zones ranging in temperature from 120° C. to 210° C. (248°−410° F.). The plastic used for encapsulation was 20 MFI (melt flow index) recycled LDPE in an amount of 750 g or 700 g, available from Da Vinci Molding, Lakeville, Massachusetts. Two samples were compounded through the extruder resulting in 25 wt % SPA and 30 wt % SPA, which were pelletized using a VariCut pelletizer. Average size of the pellets was from about 1.0 mm to about 3.5 mm (about 0.04 to about 0.15 in).

### Example 6—Encapsulated SPA Storage Stability

Encapsulated SPA (25 wt % SPA from Example 5) was mixed with bitumen binder (“Bitumen A”-PG 58-28) in quart size (500 g) steel paint containers under high sheer mixing (2500 rpm) for 2 hours at 180° C. (356° F.). Two modified bitumen samples were prepared-one containing 2.0 wt % encapsulated SPA based on total weight of the modified bitumen, and one containing 4.0 wt % encapsulated SPA based on total weight of the modified bitumen. Unmodified (neat) bitumen was used as the control. A second bitumen binder (“Bitumen B”-PG 64-22) was modified as above with (1) 2.0 wt % encapsulated SPA and (2) 4.0 wt % encapsulated SPA, both based on total weight of the modified bitumen for storage stability testing.

After blending, the samples were subjected to a 48-hour storage stability test at 163° C. according to ASTM Method D7173-20, “Determining the Separation Tendency of Polymer from Polymer-Modified Asphalt. At the conclusion of the 48-hour storage period, the top and bottom of each sample was evaluated according to AASHTO T315 (“Determining the Rheological Properties of Asphalt Binder Using a Dynamic Shear Rheometer (DSR)”). The results are provided in the following Table 4.

TABLE 4

| | | | |
|---|---|---|---|
| Sample | Top | Bottom | Difference |

Bitumen A (58-28)

| Neat | 60.7 | | N/A |
|---|---|---|---|
| 2.0 wt % Modified | 65.6 | 64.7 | 0.9 |
| 4.0 wt % Modified | 73.5 | 73.8 | 0.3 |

Bitumen B (58-28)

| Neat | 66.8 | | N/A |
|---|---|---|---|
| 2.0 wt % Modified | 70.1 | 69.5 | 0.6 |
| 4.0 wt % Modified | 74.1 | 71.6 | 2.5 |

From the above results it is seen that the modification of bitumen with the encapsulated SPA resulted in little to no separation between the binder and additives while providing a significant increase in PG (see also FIGS. 2 and 3).

### Example 7—Encapsulated SPA Long Term Storage Stability

In order to demonstrate long-term storage stability, encapsulated SPA (25 wt % SPA from Example 5) was mixed with bitumen binder (“Bitumen A”—PG 58-28) in a quart size (500 g) steel paint container under high sheer mixing (2500 rpm) for 2 hours at 180° C. (356° F.). Upon completion, 2 samples from the blend were poured into separation tubes according ASTM Method D7173-20 (“Standard Practice for Determining the Separation Tendency of Polymer from Polymer-Modified Asphalt”). At time equals zero (day zero), the 2 tubes and the remaining bitumen in the quart can of asphalt were placed into the oven at 163° C. (325° F.). This first set of 2 tubes remained in the oven for 5 days total without further mixing. The quart can was remixed at day 3 with 2 additional tubes filled with the modified bitumen and then placed back in the oven for 2 days without further mixing. The quart can was remixed one more time on day 4 and 2 additional tubes filled with the modified bitumen and placed back in the oven for 1 day without further mixing. On day 5, all six (6) tubes were removed, and one tube from each time frame-5 days from last mix, 2 days from last mix, and 1 day from last mix—was tested according to AASHTO T315 (“Determining the Rheological Properties of Asphalt Binder Using a Dynamic Shear Rheometer (DSR)”). Results of the storage stability of the tubes are provided in the following Table 5—

TABLE 5

| | PG Grade | PG Grade | Average | |
|---|---|---|---|---|
| Time from | Top | Bottom | PG Grade | Separation - |
| last mix | (° C.) | (° C.) | (° C.) | Top and Bottom |
| 1 day | 67.6 | 68.0 | 67.8 | 0.4 |
| 2 days | 65.7 | 65.3 | 65.5 | 0.4 |
| 5 days | 64.8 | 64.5 | 64.6 | 0.3 |

The above results show little separation over the 1, 2, and 5-day periods, indicating little to no separation between the binder and additives while providing an improvement in high temperature stiffness and prevention of rutting.

### Example 8—Corrosivity

PPA and SPA are considered HAZMAT Class 8 corrosives. Class 8 corrosives are substances that cause full thickness destruction of human skin upon contact within a specified time. Such materials are classified as hazardous waste and require special handling and disposal due to their potential to cause severe chemical reactions that can destroy living tissue. The UN packing group is a system that classifies dangerous goods based on their degree of danger. There are three different packing groups noted as follows—
Packing Group I: Substances presenting a high danger
Packing Group II: Substances presenting a medium danger
Packing Group III: Substances presenting a low danger
The Packing Group designation determines the degree of protective packaging required for the dangerous goods being packaged and shipped.

This Example illustrates that the hazardous classification of encapsulated SPA, and therefore its handling, can be mitigated. Two samples of encapsulated SPA were analyzed for corrosivity-Sample A (washed) and Sample B (unwashed). Each sample was evaluated according to the Organization for Economic Co-operation and Development (‘OECD’) Test No. 435 ‘In Vitro Membrane Barrier Test Method for Skin Corrosion’. The Corrositex® testing system (OECD 435, available from In Vitro International, Placentia, California) was utilized. This is a non-animal test for determining skin corrosivity which also provides GHS or UN Packing Group classification for regulatory inspection. An indicator solution permits categorization of the Samples as Category 1-strong acid or base- or Category 2-weak acid or base-material. The Samples were determined to be Category 2 material. The testing system uses a proprietary biobarrier membrane for evaluating the potential corrosivity of the Samples. The evaluation is based on the Sample penetration through the biobarrier membrane into a Chemical Detection System (‘CDS’), with the breakthrough time illustrated by a change in the color of the system. The UN packing group assignments for each Category is as follows—

TABLE 6
UN Packing Group Assignment

| Corrositex ® Category | Corrositex ® Time (minutes) | | | |
|---|---|---|---|---|
| Category 1 | 0 to 3 | >3 to 60 | >60 to 240 | >240 |
| Category 2 | 0 to 3 | >3 to 30 | >30 to 60 | >60 |
| UN Packing Group | PG I | PG II | PGIII | Non-corrosive |

The corrosivity result of the Corrositex® testing system was as follows—

TABLE 7
Results of Corrositex ® Testing

| | | Time Required for | |
|---|---|---|---|
| Sample | Category | CDS Change (minutes) | UN Packing Group |
| A | 2 | 65 | Non-Corrosive |
| B | 2 | 19 | PG II |

The above results illustrate that by proper washing of the encapsulated SPA, shipping requirements of the product can be reduced.

The above description discloses several methods and materials of the present invention. This invention is susceptible to modifications in the methods and materials, as well as alterations in the fabrication methods and equipment. Such modifications will become apparent to those skilled in the art from consideration of this disclosure or practice of the invention disclosed herein. Further, unless defined otherwise, all technical and scientific terms used herein have the same meaning as commonly understood to one of ordinary skill in the art to which this invention belongs. Consequently, it is not intended that this invention be limited to the specific embodiments disclosed herein, but that it covers all modifications and alternatives coming within the true scope and spirit of the invention as embodied in the attached claims.

We claim:

1. A composition comprising:
a first asphalt modifier, wherein the first asphalt modifier comprises at least polyphosphoric acid, and
a second asphalt modifier, wherein the second asphalt modifier comprises a plastic modifier,
wherein the second asphalt modifier encapsulates the first asphalt modifier, and
wherein the first asphalt modifier and second asphalt modifier are present in the composition in a ratio of about 1:1 to about 1:6.

2. The composition according to claim 1, wherein the plastic modifier comprises recycled plastic.

3. The composition according to claim 1, wherein the plastic modifier is chosen from linear low-density polyethylene, low-density polyethylene, high-density polyethylene, polypropylene, and combinations thereof.

4. The composition according to claim 1 further comprising at least one additional asphalt modifier, wherein the second asphalt modifier encapsulates the at least one additional asphalt modifier.

5. Asphalt comprising the composition according to claim 1.

6. A composition comprising:
a first asphalt modifier, wherein the first asphalt modifier comprises solid phosphoric acid, and
a second asphalt modifier, wherein the second asphalt modifier comprises a plastic modifier,
wherein the first asphalt modifier and second asphalt modifier are blended together to form encapsulated solid phosphoric acid,
wherein the first asphalt modifier and second asphalt modifier are present in the composition in a ratio of about 1:1 to about 1:6.

7. The composition according to claim 6, wherein the plastic modifier is chosen from linear low-density polyethylene, low-density polyethylene, high-density polyethylene, polypropylene, and combinations thereof.

8. The composition according to claim 6, wherein the plastic modifier comprises recycled plastic.

9. Asphalt comprising the composition according to claim 6.
